(19) United States
(12) Patent Application Publication
(10) Pub. No.: US 2011/0215500 A1
(43) Pub. Date: Sep. 8, 2011

(54) Reusable mold making material

(76) Inventor: Stan Edward Farrell, (US)

(21) Appl. No.: 12/660,949

(22) Filed: Mar. 8, 2010

(51) Int. Cl. B29C 33/38; C09D 201/00

(52) U.S. Cl. 264/219; 106/38.4; 106/38.51

(57) ABSTRACT

The present invention comprises of a thermoreversible flexible mold making material with higher strength and improved thermal cycling that can be melted, poured and reused to make many unique molds. The composition comprises a thermoreversible resin including a gelling hydrocolloid system and humectant, and at least one nanofiller.

### FIELD OF THE INVENTION

The present invention relates to mold making materials. More particularly, the present invention is in the technical field of flexible thermoplastic molding and casting that can be reused through melting and reforming.

### BACKGROUND OF THE INVENTION

Mold making is the process used to duplicate three dimensional models. Through the use of a mold making material a negative of a model part is made. That negative can be used to cast a second part that is the same as the original part in size and shape. The same mold can be used to make similar parts.

The term reusable mold is used in this present invention as a way to describe the ability to use the same mold making material for many different and unique molds. Reusable molds are made from thermoplastic mold making materials that can be melted and used to form a negative shape around an original part. This negative shape is then used to make a duplicate part. After one or more duplicate parts have been made, the mold material can be melted and reformed into a new mold. This process can be repeated more than twice with the same reusable mold making material.

Prototype molds provide important learning on whether a part can be made consistently, as well as provide a tool that can be used to test parts. Reusable molds that can be remade allows for small quantities of materials to be cast and made without the expenses of more complex molds. Changes to the molds can be done quickly, simply, and without additional costs.

Current state of the art thermoplastic mold making materials are typically low strength due to the precursor materials or they are very stiff. These precursor materials need to be able to be melted continuously. Also reusable mold making materials have usually taken a long time to cool because the polymeric mold making material typically has low thermal conductivity. Thermoplastic mold making materials made from gelatin, alginate or collagen shrink when they dry out without additional components within the mixture. Thermoplastic mold materials made from waxes are fragile and inflexible, making it difficult to make molds and casts with undercuts.

Typical mold making materials such as latex, silicone, and polyurethane have several drawbacks:
Current mold making materials can only make one mold. That mold can be used many times, but when you are finished making duplicates of your sculpture or artwork, the mold is no longer useful.
These one-use molds are difficult to fix if you make mistakes because the material does not stick to itself or leaves markings where the patching has occurred.
Current mold making materials are also expensive and priced out of reach for most potential mold makers.

U.S. Pat. No. 5,906,781 discusses the use of reversible gels for casting through the use of gels, but does not incorporate nanofibers or humectants. The molding process used in that patent is melted away from the sample to leave behind the shape. The gels are disposable and are not used for their reusability.

A reusable mold making material prepared and previously sold used a recipe that consisted of gelatin, glycerin, denatured alcohol, and water. The gelatin was either type A or B with 100 to 300 bloom. Ratios of the ingredients varied based on the stiffness of the final product. For example, more, gelatin and less water and glycerin produced a stiffer, higher viscosity product. This recipe had many drawbacks:
It used denatured alcohol, which is unhealthy and potentially dangerous when heated.
With denatured alcohol, it was not possible to make a mold making material that can be certified with ASTM-D4236 for non-toxic art supplies.
Food grade molds would not be possible with the use of denatured alcohol.
The mold making material had quite a bit of waste, typically ranging from 15 to 30 percent by weight because of the foam during processing.
The product also tended to grow mold or fungus easily because of the lack of any antifungal ingredients.

### SUMMARY OF THE INVENTION

It is an object of this invention to provide a stronger mold making material.

It is a further object of the invention to provide a mold making material with shorter thermal cycling.

It is another object of the invention to provide an improved reusable mold making material and process using the reusable mold making material with which many unique molds can be made with same mold making material.

It is a still further object of the invention to provide an improved reusable mold making material which is easy to use to produce different parts through melting and cooling.

In accordance with a first aspect of the invention, a flexible mold making material with higher strength and improved thermal cycling is described that can be melted, poured and reused to make many unique molds.

In a second aspect of the invention, a mold making composition, comprises a thermoreversible resin including a gelling hydrocolloid system and humectant, and at least one nanofiller.

In a third aspect of the invention, a composition used for mold making to form a thermoreversible colloidal gel comprises an aqueous solution of a humectant, a protein, and at least one nanofiller.

In a fourth aspect of the invention, a flexible mold making composition comprises: a matrix including a gelling hydrocolloid system, humectants, firming agent, and a nanofibrous material embedded in said matrix.

In a fifth aspect of the invention, a process for making at least two different moldable parts includes forming a first mold for making a first moldable part. The first mold is made from a moldable composition comprising a thermoreversible resin including a gelling hydrocolloid system and humectant, and at least one nanofiller. The first moldable part is molded using the first mold, the first moldable part from is removed from the first mold. The first mold is heated to melt the first mold to return the first mold to the moldable composition, A second mold for making a second moldable part is formed at least in part from the moldable composition. The second moldable part is molded using said second mold.

The attainment of the foregoing and related objects, advantages and features of the invention should be more readily apparent to those skilled in the art after review of the following detailed description of the invention.

### DETAILED DESCRIPTION OF THE INVENTION

The present invention is a flexible mold making material combined with nanofillers. Flexible mold making materials may be made from gelatin, alginate, carrageenan, glycerin, waxes, sugars, water, alcohol, peroxides, and polyvinyl acetate. The material works by melting the material to form a hot viscous liquid. This liquid is used to make molds for casting duplicate parts for prototypes, components, or other duplication of an original component. When melted, the low viscosity material pours over, brushes on, pours in, or covers an original component. The mold making material cools as the heat leaves the material into the surrounding environment. This flexible mold material is used to make duplicates of the original part.

The material described in this patent fixes the problems described in the prior art by the addition of nanofillers with thermal conductivity higher than the thermal conductivity of the resin. The nanofillers also provide increased strength through the nanofillers matrix formed within the resin.

The nanofiller material is embedded into the matrix to increase strength and reduce thermal cycling time. Suitable nanofiller materials for this purpose include carbon nanofibers, carbon nanotubes, nanocellulose, ceramic powder, ceramic fiber, graphite nanomaterials, silica nanofibers, metallic nanopowders, and metallic nanofibers. Nanofillers include nanofibers that may include cellulose, ceramic, and polymeric fibers. Nanofillers also include carbon nanopowders, organic nanofibers, nanoclay, and non-organic nanofibers. Nanomaterials are generally considered to have sizes up to 1 micrometer in diameter. Nanofibers can be of any length with a diameter less than 1 micrometer.

This invention covers a mold making material that is used by melting and pouring around an original part or painting on to the surface of an original part. Many casts can be performed using the same mold. This reusable mold making material is good for the mold maker and craft artist because it can be reused to make different molds without worrying about wasting mold making material (such as urethanes, silicones, or Alginate). The material is excellent for those wanting to learn and become involved in sculpting, modeling, and mold making without having to worry about mistakes or wasting material. The material is flexible, rubbery, molding compound that can be melted, poured and reused. This material is a thermoplastic mold making material with increased strength over the prior art for molding parts using many different casting materials including plaster, cement, epoxy, polyurethane, and others. The material can be used for molds, mold making and as a resin.

The reusable mold making material provides a unique solution to the 3-D sculptor and for small part prototype work. Any mistakes can be fixed using heat or by re-melting and remolding the original art piece without wasting material. Because of the reusability and ease of use, the initial cost for the artist is reduced, allowing people to experiment with the artistic medium in ways they were not able to before. The uniqueness of the product makes it well suited for many mold making projects including crafts, ornaments, prototypes, and sculptures. It is compatible with most casting materials including but not limited to urethane, epoxy, polyester, polymer clay, clay, concrete, cement, chocolate, ice cream, ice, butter, polymer metal clay, and plaster. Casting systems may also include fillers such as but not limited to powders, fibers, metal pieces, paper, plastic, ceramic, glass, and combinations thereof.

As used herein, a “gelling hydrocolloid system” refers to one or more hydrocolloid gelling agents that have been processed into a flexible mold making material for molding and casting components. The hydrocolloid gelling agents of the present invention may be polysaccharides. For example, suitable hydrocolloid gelling agents or systems include: agar, agarose, aloe mannans/xanthan, aloe mannan (deacetylated), algin/alginates, water-insoluble alginates, borate complexes of 1,3-cis diols (locust bean gum, guar gum, cassia gum, konjac), carrageenans (kappa- or iota- with appropriate cations), cassia gum/xanthan, chitosan, chitosan/alginate, chitosan/carrageenan, curdlan (a beta-1,3-glucan), gellan (Na salts are elastic, Mg salts firm), guar gum/xanthan, hyaluronic acid, konjac, deacetylated konjac, konjac/xanthan, locust bean gum/xanthan, cassia/xanthan, pectins including low-methoxyl pectins, and combinations or derivatives thereof. The ratio of components and additives, such as gelling polysaccharides, determines the elasticity, strength, flexure, melting point, and moduli of the system.

Suitable hydrocolloid gelling agents or systems that are not polysaccharides include: gelatin, whey proteins, casein, casein/carrageenan, albumins, soy protein, enzyme treated milk proteins (rennet), chondroitin sulfates, polyvinyl alcohol/borate, block co-polymers (Pluronics® and Tetronics®), polyacrylamide, polylactic acid salts, and combinations or derivatives thereof. Gelatin is preferred, but not required, for the current invention. Gelatin is a protein that is derived from meat and some dairy products. It forms a structure or matrix of intertwined and partially associate protein molecules in which the water is entrapped.

The process for producing the reusable mold making material consists of combining gelatin, water, glycerin, and nanofillers. Gelatin ratios are from 10% to 70%. Water ratios are from 20 percent to 70%. Glycerin is from 10 to 80%. Nanofillers ratios are typically 0.001% to 20%. All ratios are by weight. Alternative sources of protein and gelatin substitutes can be natural gel sources such as agar-agar (a seaweed), alginate, carrageenan, collagen, pectin, or konjak. Glycerin is an example of a humectant. The humectant has the effect of keeping the mold moist and when used in conjunction with the protein keeps the liquid within the mixture.

The firming agent (which can also be referred to as a stiffening or hardening agent) is embedded into the matrix to provide strength and structural integrity to articles made from the composition. Suitable firming agents include one or more of the following: wheat flour, other flours (including pea), clays, sawdust, starches, and other water-insoluble, water-adsorbing and/or water-absorbing particulates.

The composition further includes humectants. Suitable humectants comprise one or more of glycerin, ethylene glycol, propylene glycol, mannitol, polyethylene glycols, and others. Others can be polyols like sorbitol, xylitol or maltitol, polymeric polyols like polydextrose, or natural extracts like quillaia, lactic acid or urea.

Further possible additives include insoluble fillers other than fibers, soluble hydrocolloid fillers, water-soluble additives such as cellulose derivatives and other water-soluble hydrocolloids, water-soluble polysaccharides and other property-altering small and polymeric molecules, and water-insoluble additives such as sand, clays, vermiculite, etc. Other additives may include whitening materials and coloring agents.

Other ingredients may include carbohydrates. Carbohydrates may include dextrose, sucrose, lactose, fructose, honey, and other sugars.

Antibacterial and antifungal chemicals may also be included. Examples may include peroxides, citric acid, bleach, Triclosan, alcohol, and tetrasodium EDTA. Hydrogen peroxide is generally preferred.

The biodegradable resin technology has the potential for use in a variety of other composite applications such as wood composites, composite molding blocks, vacuum bagging operations, and other composites. It can also be used directly as a non-oil based polymer.

### EXAMPLES

The following non-limiting examples provide further details of the invention and represent best modes contemplated by the inventor for practice of the invention.

Mixtures used in samples 1 through 4 are displayed below. Mixtures were prepared by combining the water and carbon nanofiber together followed by the addition of the gelatin, and glycerin. The gelatin was 250 bloom, type A. Glycerin was vegetable glycerin. Mixing was performed by hand using a wooden stirrer. After gelling had occurred, the samples were heated to above 150 F. Cooling times were measured using a thermocouple with measurements 1 per minute.

| | grams |
|---|---|
| Sample 1 | |
| Gelatin | 124.8 |
| Glycerin | 250 |
| Water | 125.1 |
| Carbon Nanofiber | 0 |
| (Pyrograf PR-24-LA-HHT) | |
| Total mass | 499.9 |
| Sample 2 | |
| Gelatin | 125 |
| Glycerin | 250.5 |
| Water | 124.4 |
| Carbon Nanofiber | 0.5 |
| (Pyrograf PR-24-LA-HHT) | |
| Total mass | 500.4 |
| Sample 3 | |
| Gelatin | 128.1 |
| Glycerin | 248 |
| Water | 120 |
| Carbon Nanofiber | 5 |
| (Pyrograf PR-24-LA-HHT) | |
| Total mass | 501.1 |
| Sample 4 | |
| Gelatin | 112.7 |
| Glycerin | 242.7 |
| Water | 152.6 |
| Carbon Nanofiber | 21.1 |
| (Pyrograf PR-24-LA-HHT) | |
| Total mass | 529.1 |

Sample 6 was mixed without the nanofillers then split into 4 different batches to make comparisons. Each batch of 6 was mixed with different amounts of nanofillers or filler. Sample 6b used carbon nanofibers at 6.1 percent by weight. Sample 6c used silicon dioxide nanopowder with an average diameter of 500 nanometers at a concentration of 6.2 percent by weight. Sample 6d used approximately 10-20 micrometer size silicon carbide at a concentration of 19.7 percent by weight. Sample 6d had a very gritty texture and had a high viscosity as compared to 6a, 6b, and 6c. Because of the grittiness, the molds made from this material likely pick up less detail.

| | | |
|---|---|---|
| Sample 6a | | |
| Sample 6 mixture | 100.4 | grams |
| | 0 | Grams |
| | | Nanofillers |
| Sample 6b | | |
| Sample 6 mixture | 96.4 | grams |
| Carbon Nanofiber | 6.3 | grams |
| (Pyrograf PR-24-LA-HHT) | | |
| | 6.13% | Grams |
| | | Nanofillers |
| Sample 6c | | |
| Sample 6 mixture | 94.6 | grams |
| 500 nm SiO2 | 6.3 | grams |
| | 6.24% | Nanofillers |
| Sample 6d | | |
| Sample 6 mixture | 80.6 | grams |
| SiC 10-40 microns | 19.8 | grams |
| | 19.7% | Non-nano- |
| | | Filler |

Cooling rates for samples 1 through 4 demonstrate that the samples with more carbon nanofiber cooled faster. Each sample was placed into a 4.5 inch diameter polypropylene container. The volume of each sample was 23.8 cubic inches. Results are displayed below.

| From 140 | | Percent Faster | | |
|---|---|---|---|---|
| to 85 F. | Cooling Time | Cooling | | |
| Sample 1 | 117 | minutes | | |
| Sample 2 | 114 | 3% | | |
| Sample 3 | 105 | 11% | | |
| Sample 4 | 83 | 41% | | |
| From 145 | | Percent Faster | | |
| to 100 F. | Cooling Time | Cooling | | |
| Sample 1 | 57 | minutes | | |
| Sample 2 | 55 | 4% | | |
| Sample 3 | 46 | 24% | | |
| Sample 4 | 42 | 36% | | |
| | Starting | After 20 | 40 | 60 |
| | Temperature (F.) | minutes | minutes | minutes |
| Sample 1 | 146.3 | 119.6 | 107.5 | 99.3 |
| Sample 2 | 145.3 | 117.5 | 104.2 | 98.7 |
| Sample 3 | 146.84 | 115.9 | 103.1 | 95.36 |
| Sample 4 | 148.3 | 116.3 | 101.9 | 92.9 |

Cooling rates of samples 6a, 6b, 6c, and 6d were also compared. The samples were cooled in containers 2.0 inches in diameter.

Shore hardness was performed at a temperature of 67 F and displayed below.

Shore A Hardness Testing

| Sample | Shore A Hardness |
|---|---|
| Number | Testing |
| 1 | 13 |
| 2 | 18 |
| 3 | 20 |
| 4 | 28 |
| 6a | 11 |
| 6b | 18 |
| 6c | 14 |
| 6d | 10 |

Results for cooling Samples 6a through 6d are below. Both carbon nanofibers and ceramic nanomaterials cooled the sample more effectively than the undoped samples. Sample 6d demonstrates the cooling rate with a high percentage of micron sized silicon carbide particles. However, the large percentage of silicon carbide did not improve the hardness of the material and made the gel more difficult to use for mold making applications.

| From 140 to 85 F. | Cooling Time | | | |
|---|---|---|---|---|
| Sample 6a | 65 | minutes | | |
| Sample 6b | 57 | 14% | | |
| Sample 6c | 55 | 18% | | |
| Sample 6d | 50 | 30% | | |
| From 145 to 100 F. | Cooling Time | | | |
| Sample 6a | 38 | minutes | | |
| Sample 6b | 34 | 12% | | |
| Sample 6c | 33 | 15% | | |
| Sample 6d | 28 | 36% | | |
| | Starting | After 20 | | |
| | Temp | minutes | 40 minutes | 60 minutes |
| Sample 6a | 151.5 | 121.1 | 101.1 | 89.4 |
| Sample 6b | 151.5 | 117 | 97.1 | 87.1 |
| Sample 6c | 150.1 | 115.3 | 96.3 | 85.4 |
| Sample 6d | 150.5 | 111.7 | 93.1 | 82.8 |

Sample 7 was prepared using the following recipe:

| | Grams of | |
|---|---|---|
| Ingredients | material | |
| Water | 3290 | |
| Glycerin | 6716 | |
| Gelatin | 3,549.00 | |
| fragrance | 4.9 | |
| hydrogen | 127.6 | |
| peroxide 3% | | |
| citric acid | 16.2 | |
| Total weight | 13703.7 | grams |

The material was prepared by first mixing cool water and glycerin together. The gelatin was added into this mixture and stirred with a mixer. Mixing continued until the mixture began to gel and solidify. This mixture was allowed to set for up to 24 hours. This solution was then heated using a double boiler until the gel melted into a liquid. Hydrogen peroxide and the fragrance (lavender) were mixed together prior to being mixed into the water, glycerin, and gelatin mixture. The citric acid was then mixed into the liquid mixture. After mixing everything together, the heat was removed and the product was allowed to cool. After the material temperature reaches below approximately 100 F, the mixture was heated up to above 130 F. At that point the heat was removed again. When the temperature reaches below 100 F the heat was added again. After the temperature reaches above about 130, the mixture was separated into smaller containers. The mixture was transparent amber color with little to no bubbles.

Approximately 200 grams of sample 7 was separated into a container, called sample 7a. Sample 7a was used to make a mold. It was melted in the microwave for 45 seconds to form a liquid. A dog figurine was placed into a plastic cup as the original part to be duplicated. A mold release (Huron Technologies, Silicone Mold Release) was sprayed over the dog figurine. The liquid sample 7a was poured over the dog figurine. Sample 7a cooled at room temperature to form a rubber mold. After cooled, the original dog figurine part was removed leaving a negative shape for the mold. Plaster of Paris was mixed and poured into the mold and allowed to solidify for 4 hours. After 4 hours the Plaster dog figurine duplicate was removed from the mold. The mold was then placed into a plastic container and remelted to form a liquid. This liquid was used to prepare a second mold. The second part was an ornament in the shape of a peace sign. The original peace sign was coated with a mold release. Vegetable oil was used as the mold release. The liquid mold material was poured over the peace sign and allowed to cool to form a rubbery mold. The original part was removed from the mold making material. Urethane resin (ComposiCast-3770) was mixed and poured into the mold. After the urethane had cured, the new duplicate peace sign was removed. A second duplicate peace sign was made using the same mold. After finishing with the second mold, the mold making material was placed back into a plastic container and remelted in the microwave.

200 grams of sample 7 was mixed with 1 gram of carbon nanofiber and called sample 8. Sample 8 was used to make the same molds and duplicate castings as was made with sample 7b. The same parts were duplicated.

### CONCLUSION, RAMIFICATION AND SCOPE

It should now be readily apparent to those skilled in the art that a novel strand based composite article of manufacture and molding process capable of achieving the stated objects of the invention has been provided. The strand based composite article of manufacture has reduced production of volatile organic compound emissions. It has improved performance after exposure to moisture and equivalent or improved properties with a lower density. The use of wax is not necessary in the composite article of manufacture.

Accordingly the reader will see that, according to the invention, I have provided a means to reproduce parts using a mold making material that can be reused for a variety of unique molds and casts. The mold making material is improved through the addition of nanofillers. The addition of the nanofillers serves to increase the hardness values of the resin and reduce the cooling temperature. The increased hardness holds the shape of the molded object more effectively. This increased heat transfer reduces the time necessary for heating and cooling, thus makes the material more user-friendly and more efficient.

It should further be apparent to those skilled in the art that various changes in form and details of the invention as shown and described may be made. For example, a stronger flexible thermoplastic rubber used for mold making can be made with any number of additions and not just the components listed. Colors, other filler materials, antibacterials, and smells can also be included. It is intended that such changes be within the spirit and scope of this invention as defined in the following claims.

1. A mold making composition, comprising a thermoreversible resin including a gelling hydrocolloid system and humectant, and at least one nanofiller.

2. The composition of claim 1, wherein the average particle size of said nanofiller is below 1 micrometer in diameter.

3. The composition of claim 1 additionally comprising a conductive material to reduce thermal cycling time.

4. The composition of claim 1, wherein said nanofiller comprises nanofibers.

5. The composition as claimed in claim 1, wherein said nanofiller comprises carbon.

6. The composition as claimed in claim 1, wherein said nanofiller comprises a ceramic.

7. The composition of claim 1 wherein said gelling hydrocolloid system is selected from the group consisting of gelatin, agar, agarose, aloe mannans/xanthan, aloe mannan (deacetylated), algin/alginates, water-insoluble alginates, borate complexes of 1,3-cis diols, carrageenans, cassia gum/xanthan, chitosan, chitosan/alginate, chitosan/carrageenan, curdlan, gellan, guar gum/xanthan, hyaluronic acid, konjac, deacetylated konjac, konjac/xanthan, locust bean gum/xanthan, cassia/xanthan, pectins, and combinations or derivatives thereof.

8. The composition of claim 1 wherein said humectant is selected from the group consisting of glycerin, ethylene glycol, propylene glycol, mannitol, sorbitol, and polyethylene glycols.

9. A composition used for mold making to form a thermoreversible colloidal gel comprising an aqueous solution of a humectant, a protein, and at least one nanofiller.

10. The composition of claim 9, wherein protein is selected from the group consisting of gelatin, alginate, collegeenan, pectin, konjak, agar, or a mixture thereof.

11. A flexible mold making composition comprising: a matrix including a gelling hydrocolloid system, humectants, firming agent, and a nanofibrous material embedded in said matrix.

12. The composition of claim 11 wherein said gelling hydrocolloid system comprises one or more polysaccharides.

13. The composition of claim 11 wherein said gelling hydrocolloid system is selected from the group consisting of gelatin, agar, agarose, aloe mannans/xanthan, aloe mannan (deacetylated), algin/alginates, water-insoluble alginates, borate complexes of 1,3-cis diols, carrageenans, cassia gum/xanthan, chitosan, chitosan/alginate, chitosan/carrageenan, curdlan, gellan, guar gum/xanthan, hyaluronic acid, konjac, deacetylated konjac, konjac/xanthan, locust bean gum/xanthan, cassia/xanthan, pectins, and combinations or derivatives thereof.

14. The composition of claim 11 wherein said humectant is selected from the group consisting of glycerin, ethylene glycol, propylene glycol, mannitol, sorbitol, and polyethylene glycols.

15. The composition of claim 11 wherein said nanofibrous material is selected from the group consisting of nanocellulose fibers, carbon nanofibers, carbon nanomaterials, nanoclay, nanoceramics, carbon nanotubes, glass nanofibers, and combinations or derivatives thereof.

16. The composition of claim 11 wherein said mold making composition is an aqeous admixture, and wherein the concentration of said one or more hydrocolloid gelling agents in said admixture is about 0.5 percent by weight to about 60 percent by weight, the concentration of said one or more firming agents in said admixture is about 0.0 percent by weight to about 50 percent by weight, the concentration of said one or more humectants in said admixture is about 0.1 percent by weight to 70 percent by weight, and the concentration of said nanofiller material in said admixture is about 0.001 percent by weight to about 15 percent by weight.

17. A process for making at least two different moldable parts, which comprises forming a first mold for making a first moldable part, said first mold being made from a moldable composition comprising a thermoreversible resin including a gelling hydrocolloid system and humectant, and at least one nanofiller, molding said first moldable part using said first mold, removing said first moldable part from said first mold, heating said first mold to melt said first mold to return said first mold to said moldable composition, forming a second mold for making a second moldable part at least in part from said moldable composition, and molding said second moldable part using said second mold.

18. A process for making at least two different moldable parts, which comprises forming a first mold for making a first moldable part, said first mold being made from a moldable composition comprising an aqueous solution of a humectant, a protein, and at least one nanofiller, molding said first moldable part using said first mold, removing said first moldable part from said first mold, heating said first mold to melt said first mold to return said first mold to said moldable composition, forming a second mold for making a second moldable part at least in part from said moldable composition, and molding said second moldable part using said second mold.

19. A process for making at least two different moldable parts, which comprises forming a first mold for making a first moldable part, said first mold being made from a moldable composition comprising a matrix including a gelling hydrocolloid system, humectants, firming agent, and a nanofibrous material embedded in said matrix, molding said first moldable part using said first mold, removing said first moldable part from said first mold, heating said first mold to melt said first mold to return said first mold to said moldable composition, forming a second mold for making a second moldable part at least in part from said moldable composition, and molding said second moldable part using said second mold.
